(19) United States
(12) Patent Application Publication
(10) Pub. No.: US 2009/0276266 A1
(43) Pub. Date: Nov. 5, 2009

(54) WORKFLOW MANAGEMENT METHOD USING AN IMAGE FORMING APPARATUS

(75) Inventor: Masashi Nishiyama, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/434,539

(22) Filed: May 1, 2009

(30) Foreign Application Priority Data
May 2, 2008 (JP) 2008-120502

(51) Int. Cl. G06Q 10/00

(52) U.S. Cl. 705/7

(57) ABSTRACT

An image forming apparatus determines whether workflow information is included in a received print request. When the workflow information is included in the received print request, the image forming apparatus analyzes the workflow information and calculates a limit date/time to be notified to workers taking charge of respective steps of a workflow. The image forming apparatus prepares E-mail data including information that indicates the limit date/time. The image forming apparatus sends the prepared E-mail by referring to mail addresses of the workers taking charge of the respective steps of the workflow.

### BACKGROUND OF THE INVENTION

1. Field of the Invention

The present invention relates to an information processing system for managing a flow of work steps, which are performed by workers on printed-out materials, through communication between an information processing apparatus and an image forming apparatus.

2. Description of the Related Art

For the purpose of smoothly progressing jobs and tasks in companies, it has hitherto been performed to manage schedules of individual workers by utilizing a schedule management system. The schedule management system has such a limit time notifying function as described, for example, in Japanese Patent Laid-Open No. 2003-333181. The term “limit time notifying function” implies a function of notifying the fact that the limit time (due date) of a certain matter is nearing, or a function of prompting a worker to take an action for a certain pending matter. In practice, a previously registered schedule is notified to a designated terminal at a designated time, thus reminding the relevant worker of the schedule.

On the other hand, a series of task procedures in which a plurality of workers are engaged, such as related to business proceedings and planning paper, are managed by defining the series of task procedures in the form of a workflow.

An online workflow support system is realized which handles management and progress of tasks in accordance with the series of task procedures in electronic fashion, and which successively manages and progress a flow of the tasks online.

In the online workflow support system, employing a schedule management system is proposed to prevent a delay in the workflow (see, e.g., Japanese Patent Laid-Open No. 2006-185011).

However, the workflow is not all handled on the electronic base, and some workflow is still handled on the paper basis. The paper-based workflow includes, for example, the case handling documents that are legally required to be sealed or signed on actual paper.

A large-scale workflow support system is needed in order to transfer electronic information online among many terminals including external organizations. Further, in a workflow where electronic information frequently moves over a network, performance may deteriorate significantly and efficiency may reduce correspondingly depending on data size of the electronic information and network environments. For that reason, an offline paper-based workflow still remains in many fields.

The paper-based workflow is advantageous in not needing a large-scale workflow system and in having higher convenience when notes or documents are circulated in the form of paper, depending on characteristics of the circulated notes or documents. However, the paper-based workflow has the following problems.

In an example of the paper-based workflow, documents, such as specifications and a patent file wrapper, are circulated among a plurality of workers for the purpose of checking. On that occasion, the documents are circulated with attachment of a memo indicating a final limit date and a list of workers among whom the documents are to be circulated.

Thus, individual workers perform checking of the documents in consideration of the order of circulation and the final limit date. However, a time taken for each worker to perform the checking is left to the discretion of the worker.

Further, because of the offline paper-based workflow disconnected from the network, a difficulty arises in monitoring the progress status of the checking work unlike an online system. Accordingly, it is also difficult to notify proper limit dates to the individual workers taking in charge of respective steps.

In the offline paper-based workflow, therefore, the workflow tends to stagnate and a delay tends to occur in the entire workflow. Even when limit time notifying systems described in Japanese Patent Laid-Open No. 2003-333181 and Japanese Patent Laid-Open No. 2006-185011 are applied to that case, the following problem still remains.

In the systems described in Japanese Patent Laid-Open No. 2003-333181 and Japanese Patent Laid-Open No. 2006-185011, the limit time is notified to each worker at the start of the workflow. Accordingly, if one worker delays the assigned limit time in the course of the flow, the limit time previously notified to each worker in subsequent steps becomes meaningless.

### SUMMARY OF THE INVENTION

An exemplary embodiment of the present invention provides a scheme capable of managing a flow of work steps, which are performed by workers on printed-out materials, in accordance with workflow information contained in a print request.

According to an aspect of the present invention, in an image forming apparatus configured to receive print information from an information processing apparatus and to process the print information, the image forming apparatus includes a determining unit configured to determine whether the print information includes workflow information, a limit date calculating unit configured to, when the determining unit determines that the print information includes the workflow information, analyze the workflow information and calculate a limit date until which a first step constituting a workflow is to be completed, a mail preparing unit configured to prepare a notification mail which includes information indicating the limit date of the first step, and a mail sending unit configured to send the notification mail prepared by the mail preparing unit to an address of a worker taking charge of the first step, the address of the worker being specified based on the workflow information.

Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 illustrates an overall configuration of a workflow support system to which an image forming apparatus representing a first exemplary embodiment is applied.

FIG. 2A is a block diagram illustrating a configuration of a controller unit in one example of the image forming apparatus illustrated in FIG. 1.

FIG. 2B is a block diagram illustrating a configuration of a controller unit in another example of the image forming apparatus illustrated in FIG. 1.

FIG. 3 is a block diagram illustrating a hardware configuration of each of a server and a client terminal illustrated in FIG. 1.

FIG. 4 is a block diagram illustrating a software module configuration of the image forming apparatus illustrated in FIG. 1.

FIG. 5 illustrates an example of a user interface (UI) displayed in an information processing apparatus representing the first exemplary embodiment.

FIG. 6 illustrates an example of workflow information that is set on the UI screen illustrated in FIG. 5 and is sent to the image forming apparatus.

FIG. 7 is a flowchart illustrating a print process in the image forming apparatus illustrated in FIG. 1.

FIG. 8 illustrates an example of E-mail data prepared by the image forming apparatus illustrated in FIG. 1.

FIG. 9 illustrates an example of E-mail data replied to the image forming apparatus illustrated in FIG. 1.

FIG. 10 is a flowchart illustrating an example of data processing procedures in the image forming apparatus representing the first exemplary embodiment.

FIG. 11 illustrates an example of a reply mail sent from the image forming apparatus representing the first exemplary embodiment.

FIG. 12 illustrates an example of a step model in a workflow system representing a second exemplary embodiment.

FIG. 13 illustrates a memory map of a storage medium storing various data processing programs which are readable by the image forming apparatus representing the exemplary embodiment.

### DESCRIPTION OF THE EMBODIMENTS

Preferred exemplary embodiments of the present invention will now be described in detail in accordance with the accompanying drawings.

### <Explanation of System Configuration>

### First Exemplary Embodiment

### <Workflow Support System>

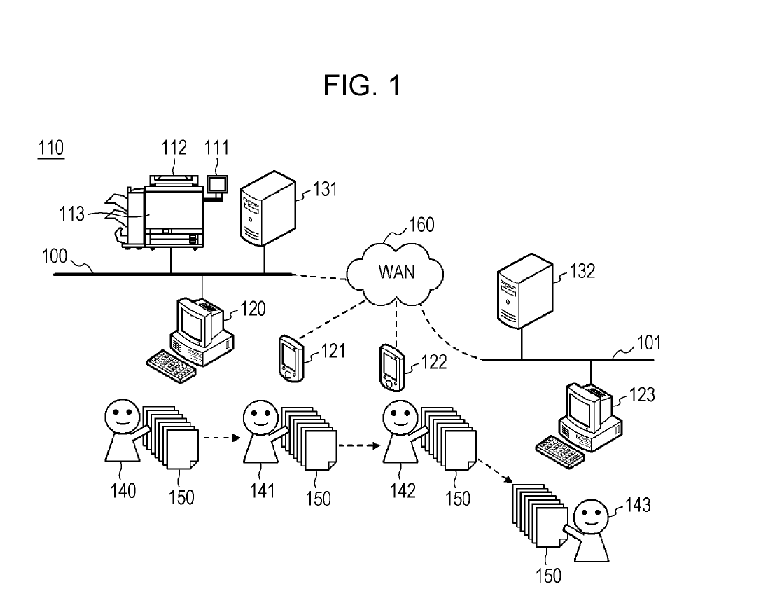

FIG. 1 illustrates an overall configuration of a workflow support system to which an image forming apparatus representing a first exemplary embodiment is applied. In the workflow support system, an image forming apparatus configured to output paper documents is, for example, a printer, a copying machine, or an MFP (Multi Function Peripheral). The image forming apparatus receives print information from an information processing apparatus and executes a workflow process and a print process, as described later. The print information is generated by a printer driver, which is installed in the information processing apparatus and which is adapted for the image forming apparatus. When the image forming apparatus has the Web server function, an operating screen (user interface) to make workflow process setting (described later) can be presented from the image forming apparatus to the information processing apparatus and can be displayed through a browser in the information processing apparatus so that workflow information is obtained from a print requesting worker with respect to the displayed operating screen.

Each of workers, illustrated in FIG. 1, operates a terminal for sending and receiving electronic mails (E-mails) to and from the image forming apparatus to execute a process of receiving a step task instruction from the image forming apparatus and a process of sending a step completion mail to the image forming apparatus. The terminal operated by the user is, for example, a PDA (Personal Digital Assistant), a cell phone, or a client PC.

The illustrated workflow support system represents an example in which an output document of the image forming apparatus 110 is circulated among respective workers from hand to hand and the workers successively perform steps which have been previously set and assigned to them, thus completing a predetermined workflow.

The image forming apparatus 110 is connected, as illustrated in FIG. 1, to a LAN 100 constituted as Ethernet (registered trademark). A file server computer (hereinafter referred to simply as a “server”) 131, which also functions as an E-mail server, and a client terminal 120 are further connected to the LAN 100 in the workflow support system.

A server 132 and a client terminal 123 are connected to a LAN 101. The LAN 100, the LAN 101, the client terminals 120 and 123, and other client terminals 121 and 122 are interconnected via a WAN (public line) 160.

In the workflow support system according to this exemplary embodiment, the number of connections is not limited to the illustrate one. While a LAN is employed as an interconnection method in this exemplary embodiment, the interconnection method is not limited to the LAN. For example, a serial transmission system, such as USB, and a parallel transmission system, such as Centronics or SCSI, are also applicable.

Workers 140 to 143 perform respective tasks preset for steps of the workflow. A circulating document 150 is circulated through an offline workflow in this exemplary embodiment.

The image forming apparatus 110 has not only a copy function and a facsimile function, but also a data sending function of reading a document image and sending read image data to various apparatuses (devices) on the LAN 100. Further, the image forming apparatus can prepare an E-mail including the image data as an attached file and can send the E-mail by employing the server 131.

The image forming apparatus 110 has a function of interpreting and rendering PDL (Page Description Language) data and can receive and print the PDL data instructed from some computer that is connected to the LAN 100.

The image forming apparatus 110 can store images read by the image forming apparatus 110 itself and the PDL data instructed from some computer, which is connected to the LAN 100, in a particular area of an external storage, e.g., a hard disk, in the image forming apparatus 110.

The image forming apparatus 110 can read a document image and store the document image as a digital image in the hard disk, and further can print the digital image stored in the hard disk.

The image forming apparatus 110 includes the following devices.

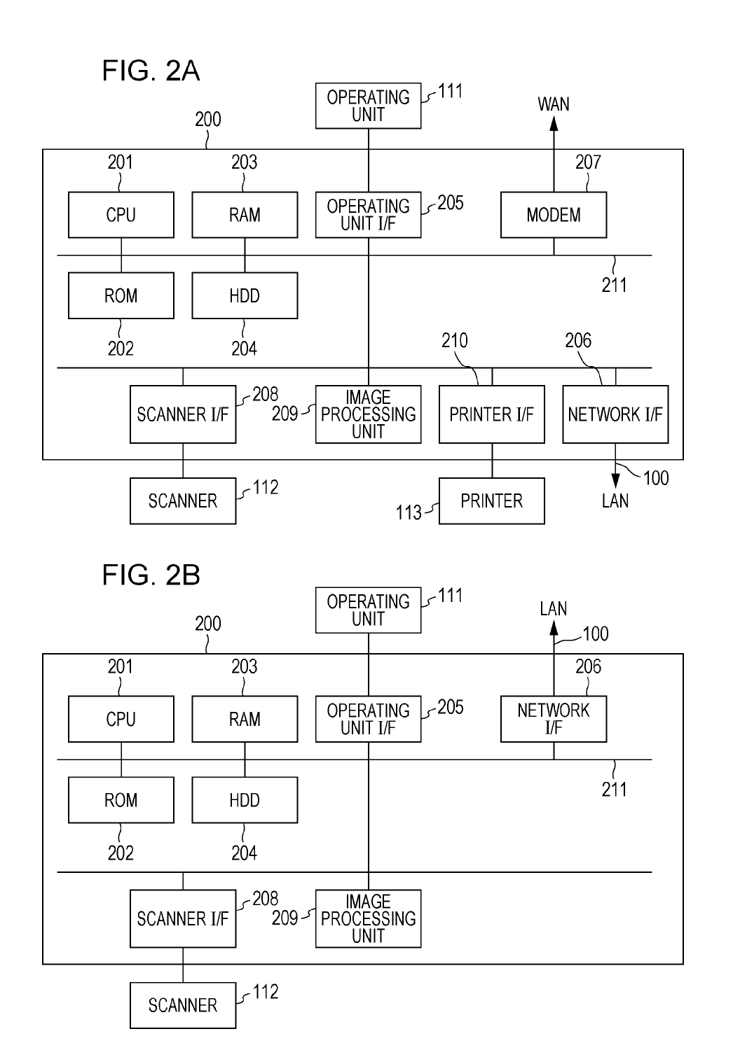

The image forming apparatus 110 includes a scanner 112 (FIG. 2A) serving as an image input device, and a printer 113 serving as an image output device. Further, the image forming apparatus 110 includes a controller unit 200 (FIG. 2A) for supervising overall operation control of the image forming apparatus 110, and an operating unit 111 that serves as a user interface (UI).

In the scanner 112, light reflecting from an image on an original document with exposure scan is input to a CCD (Charge Coupled Device) sensor for conversion of image information to an electrical signal. The electrical signal is converted to a brightness signal for each of three colors R, G and B. The brightness signal is output as image data to the controller unit 200.

Original documents are set in a document feeder. When a user instructs the start of reading through the operating unit 111, a document read instruction is issued from the controller unit 200 to the scanner 112.

Upon receiving the document read instruction, the scanner 112 feeds the original documents one by one from the document feeder and executes a document read operation. A manner of reading the original document is not limited to automatic feed using the document feeder. Alternatively, an original document can be scanned by placing the document on a glass surface (not shown) and moving an exposure unit.

The printer 113 is an image forming device that forms an image on a sheet based on the image data received from the controller unit 200.

While electrophotography using a photosensitive drum or a photosensitive belt is employed as an image forming technique in this exemplary embodiment, practical embodiments of the present invention are not limited to the use of electrophotography. For example, an ink jet technique of ejecting ink from a small nozzle array to print an image on a sheet is also applicable.

In each of the client terminals 120 to 123, a CPU executes an operating system (OS) and various application programs such that various types of data processing are performed with the applications executed under control of the OS. This is similarly applied to the server computers 131 and 132 as well.

### <Details of Controller Unit>

FIGS. 2A and 2B are each a block diagram illustrating a configuration of the controller unit 200 in the image forming apparatus 110 illustrated in FIG. 1. More specifically, FIG. 2A illustrates one example of the image forming apparatus, which is connected to a WAN (Wide Area Network) through a modem 207 and which is also connectable to the relevant network (LAN). FIG. 2B illustrates another example of the image forming apparatus connectable to the relevant network (LAN) alone. Electronic mailing is realized with a CPU executing a mail processing program to send and receive E-mails.

Referring to FIGS. 2A and 2B, the controller unit 200 is electrically connected to the scanner 112 and the printer 113. On the other hand, the controller unit 200 is connected to the server 131 and the client terminal 120 via the LAN 100. Thus, the controller unit 200 can input and output image data and device information.

A CPU 201 controls accesses to various devices, which are connected to the LAN, in a supervisory manner in accordance with a control program, etc. stored in a ROM 202, and also controls various types of processing executed within the controller unit 200 in a supervisory manner. The ROM 202 further stores an apparatus boot program, etc. A RAM 203 serves as not only a system work memory necessary for the operation of the CPU 201, but also as a memory for temporarily storing image data. The RAM 203 is made up of an SRAM capable of holding stored data even after power-off, and a DRAM in which stored data is erased after power-off. A HDD 204 is a hard disk drive capable of storing system software and image data.

An operating unit interface (I/F) 205 is an interface for connecting a system bus 211 and an operating unit 111. The operating unit I/F 205 receives, from the system bus 211, image data to be displayed on the operating unit 111, and outputs the received image data to the operating unit 111. Also, the operating unit I/F 205 outputs, to the system bus 211, information input from the operating unit 111.

A network interface (I/F) 206 is connected to the LAN 100 and the system bus 211 for inputting/outputting of information. A modem 207 is connected to a WAN 600 and the system bus 211 for inputting/outputting of information. A scanner interface (I/F) 208 executes correction, processing and editing on image data received from the scanner 112.

The scanner I/F 208 determines, for example, whether the received image data corresponds to a color document or a monochrome document, and whether the received image data corresponds to a character document or a photo document. The determination result is attached to the image data. Such incidental information is called here attribute data.

An image processing unit 209 executes, for example, directional conversion and image compression/expansion of image data. The image processing unit 209 can also combine images stored in the HDD 204 into one image. A printer interface (I/F) 210 receives image data sent from the image processing unit 209 and executes an image forming process on the image data while referring to the attribute data attached to the image data. The image data after being subjected to the image forming process is output to the printer 113.

An instruction from the user to the image forming apparatus 110 and presentation of information from the image forming apparatus 110 to the user can be executed through, e.g., the operating unit 111, or can also be executed from the client terminal 120 via the LAN 100.

### <Hardware Configuration of Computer>

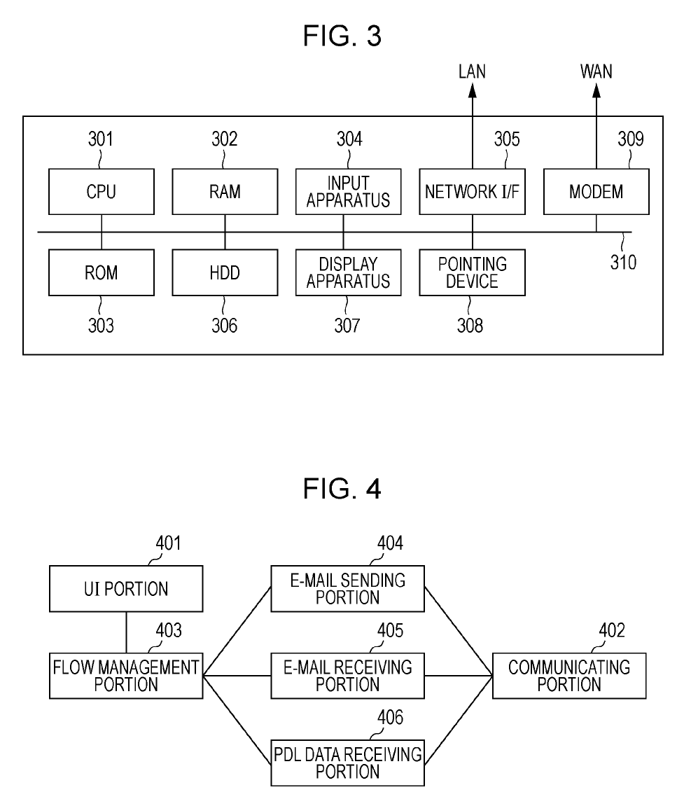

FIG. 3 is a block diagram illustrating a hardware configuration of each of the servers 131 and 132 and the client terminals 120 to 123 illustrated in FIG. 1.

Referring to FIG. 3, a CPU 301, a RAM 302, a ROM 303, a network I/F 305, a hard disk drive (HDD) 306, and a modem 309 are interconnected via a system bus 310 in a way capable of communicating with one another.

A display apparatus 307, an input apparatus 304 such as a keyboard, and a pointing device 308 are interconnected via the system bus 310 in a way capable of communicating with one another.

Control programs are previously stored in the ROM 303 or the HDD 306. The CPU 301 functions as a computer by reading the control programs from the ROM 303 or the HDD 306 onto the RAM 302, as required, and by executing the control programs.

The CPU 301 displays various kinds of information on the display apparatus 307 and receives, e.g., a user instruction from the input apparatus 304 or the pointing device 308. In addition, the CPU 301 communicates with other apparatuses (devices) via the network I/F 305 and the modem 309.

### <Software Configuration of Image Forming Apparatus>

FIG. 4 is a block diagram illustrating a software module configuration of the image forming apparatus 110 illustrated in FIG. 1. Software modules regarding control of the various functions of the image forming apparatus 110 are loaded in the RAM 203 and are executed by the CPU 201. A UI portion 401 is a software module configured to display views on the operating unit 111 through the operating unit I/F 205 and to process an input entered by the user from the operating unit 111.

A communicating portion 402 is a software module configured to perform communication through operations of the network I/F 206 and the modem 207. A flow management portion 403 is a software module configured to analyze a workflow setting file and to store and manage the workflow setting file. Details of the workflow setting will be described later.

An E-mail sending portion 404 is a software module configured to prepare E-mail data and to send the E-mail data to a predetermined destination through the communicating portion 402. An E-mail receiving portion 405 is a software module configured to analyze the E-mail data received through the communicating portion 402.

A PDL data receiving portion 406 is a software module configured to analyze PDL data and attribute information associated with the received PDL data, which are received from a printer driver in the client terminal 120 through the communicating portion 402.

### <Paper Output for Paper-Based Workflow>

A description is first made of an example of processing in which a user positioning at the start of a paper-based workflow outputs a document for circulation by using the client terminal 120 and the image forming apparatus 110.

In FIG. 1, the user positioning at the start of a paper-based workflow is, for example, the worker 140. The user prepares a document by using an application program that runs on the client terminal 120. Then, the user prints the prepared document in the image forming apparatus 110 by using the printer drive adapted for the image forming apparatus 110. At that time, the user inputs workflow information as part of setting of the printer driver.

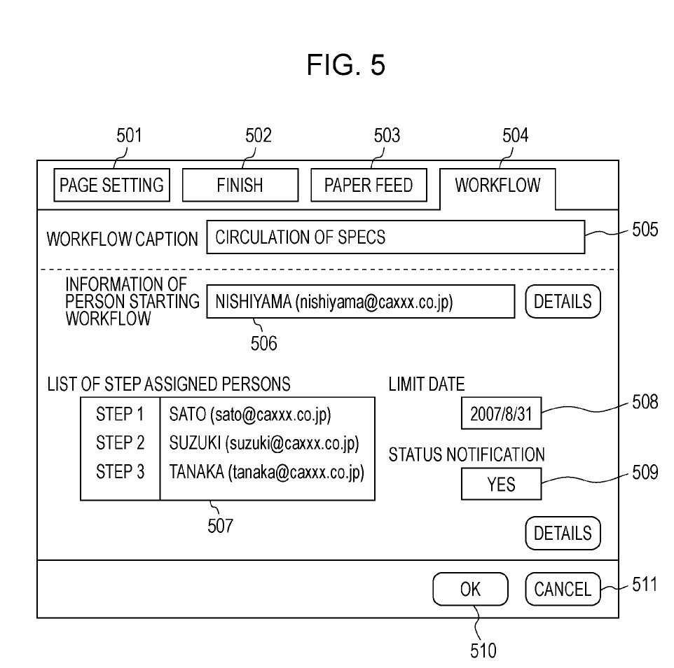

FIG. 5 illustrates an example of a user interface (UI) displayed in the information processing apparatus representing the first exemplary embodiment. The illustrated example indicates a setting screen (UI) provided by the printer driver in the client terminal 120.

Referring to FIG. 5, the setting screen includes a page setting tab 501 to make setting for the number of prints, imposition, etc., a finish tab 502 to make setting for stapling and bookbinding, and a paper feed tab 503 to make setting for a paper feed stage. In this first exemplary embodiment, a workflow tab 504 to make setting for the workflow is further prepared at the right end of a tab row.

FIG. 5 represents the setting screen in a state that the workflow tab 504 to make setting for the workflow setting is selected.

The user inputs a workflow caption, e.g., “Circulation of specs”, in a field 505 of “WORKFLOW CAPTION” and further inputs “Nishiyama”, for example, in a field 506 of “INFORMATION OF PERSON STARTING WORKFLOW”.

The information of the person starting workflow is provided as an E-mail address of the user starting the workflow. Instead of directly inputting the information of the person starting workflow by the user, that information can also be designated through a search of a user database stored in the client PC (terminal) 120 or another server.

Further, the user inputs, in a field 507 of “LIST OF STEP ASSIGNED PERSONS”, E-mail addresses of workers whom steps of the workflow are respectively assigned (i.e., workers taking in charge of respective steps of the workflow).

For example, the list of step assigned persons corresponds to E-mail addresses of the workers 141 to 143 illustrated in FIG. 1. A limit date (due time) of the workflow, e.g., “2007/8/31”, is input in a field 508 of “LIMIT DATE”.

When the user wants to confirm the progress status of the workflow, the user selects “YES” in a field 509 of “STATUS NOTIFICATION”. With that selection, upon completion of each step, an E-mail indicating the progress status of the workflow is sent from the worker taking in charge of each step to the worker 140 positioning at the start of the workflow. Reference numeral 510 denotes an OK button which is pressed to definitely confirm the setting details. Reference numeral 511 denotes a cancel button which is pressed to close the displayed UI screen.

With the above-described setting, the worker 140 can ascertain how far the circulating document is actually circulated. The workflow information having been input as described above is sent to the image forming apparatus 110, along with the PDL data, from the printer driver via the LAN 100.

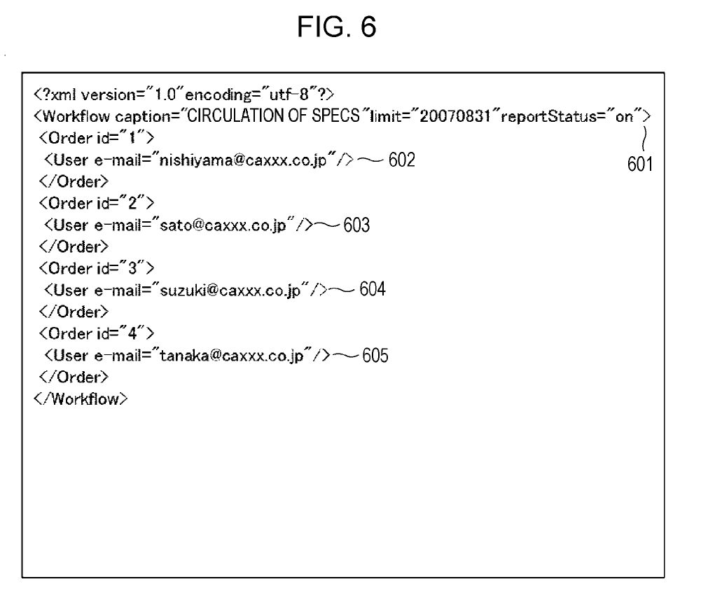

FIG. 6 illustrates an example of the workflow information that is set on the UI screen illustrated in FIG. 5 and is sent to the image forming apparatus 100. In other words, FIG. 6 illustrates an example of the workflow information sent from the printer driver to the image forming apparatus 100. In this exemplary embodiment, the workflow information is described in the XML format.

It is, however, to be noted that the workflow information can also be described in another specific format instead of the XML format.

Referring to FIG. 6, a tag 601 represents summary information of the workflow, including a workflow caption, a limit date designating a final limit date (deadline) of the workflow, and status-notification ON/OFF information as to whether step progress information is to be notified or not for each step.

Tags 602 to 605 represent the setting and the order of respective steps of the workflow. An “id” element in an “Oder” tag represents the order. The order of each step can be provided by the order of appearance of a corresponding tag. Herein, the tags 602 to 605 serve as step instruction information based on which the steps are successively progressed while output materials printed by the image forming apparatus are circulated. Accordingly, the CPU 201 can confirm the number of steps, the sequence of steps, etc. by referring to the step instruction information.

The tag 602 represents information of the person (worker) positioning at the start of the workflow. An E-mail address of that worker is put in a “User” tag. Similarly, E-mail addresses of the other workers are put respectively in the tags 603 to 605. Such E-mail addresses correspond to the E-mail addresses of the users set in the field 507 of “LIST OF STEP ASSIGNED PERSONS” illustrated in FIG. 5.

In the image forming apparatus 110, when PDL data and an XML file in the format illustrated in FIG. 6 are received from the printer driver through the communicating portion 402, the XML file is passed from the PDL data receiving portion 406 to the flow management portion 403. The flow management portion 403 analyzes the received XML file for conversion to the internal format, and then stores converted data as flow information in the HDD 204. The foregoing is a processing sequence when a paper document for the paper-based workflow is output.

Thus, the sequence of the paper-based workflow and the addresses of the workers taking in charge of the respective steps can be stored in the image forming apparatus 110. One or more printed-out sheets, i.e., the printing result obtained as described above, are handled away from the network and are successively circulated among the workers offline from hand to hand directly or via mails, for example.

While, in the above-described exemplary embodiment, the workflow setting is executed by using the printer driver in the client terminal 120, the workflow setting is just required to be established in the image forming apparatus. For example, the image forming apparatus can be a Web server so as to receive the workflow setting and the print image through Web service or a Web page.

### <Sending of Limit Date Notification Mail in Image Forming Apparatus>

A processing sequence in sending a limit date (time) notification mail to each of the workers taking in charge of the respective steps of the workflow will be described below. The following description further includes a process of sending a progress (status) mail to the worker positioning at the start point of the workflow.

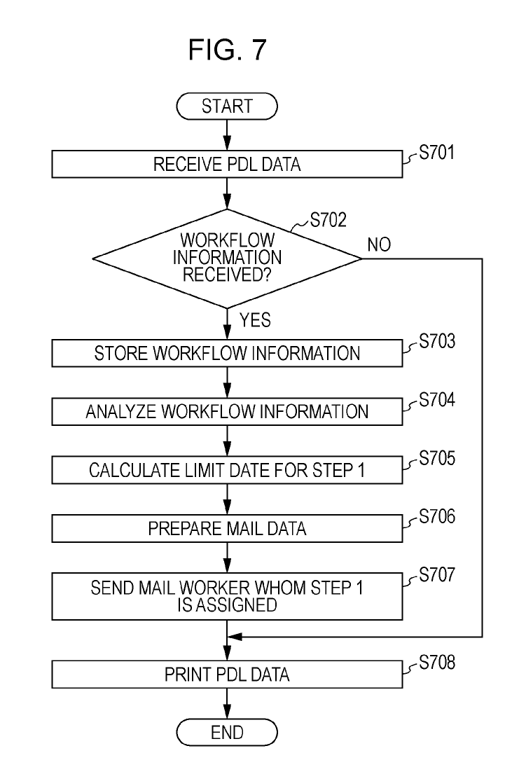

FIG. 7 is a flowchart illustrating a print process in the image forming apparatus illustrated in FIG. 1. The illustrated flowchart represents the processing executed in the image forming apparatus 110 to print PDL data when print information is received from the information processing apparatus in a workflow management process. In FIG. 7, S701 to S708 indicate successive steps. Those steps are executed by the CPU 201, illustrated in FIG. 2, executing the control program loaded in the RAM 203.

In S701, the CPU 201 receives PDL data, sent from the printer driver in the client terminal 120, through the network I/F 206. When the workflow information has already been set on the workflow setting screen illustrated in FIG. 5, the CPU 201 receives, along with the PDL data, an XML file describing the workflow information in the format illustrated in FIG. 6 through the network I/F 206.

In S702, the CPU 201 determines whether the received PDL data contains the workflow information. If the CPU 201 determines that the XML file in the format illustrated in FIG. 6 is received, the CPU 201 advances to step S703. If the CPU 201 determines that the XML file is not received, the CPU 201 advances to step S708. In S708, the PDL data is subjected to rendering and is printed by the printer 113, whereby the processing is brought to an end.

In S703, the CPU 201 executes the control program stored in the HDD 204. More specifically, the CPU 201 analyzes the received XML file, converts the workflow information to the internal format, and then stores converted data in the HDD 204 under management of the flow management portion 403.

The workflow data is managed using ID uniquely allocated thereto on the image forming apparatus 110. While this exemplary embodiment generates each ID by using UUID (Universally Unique Identifier), each ID can also be generated by using a method other than the UUID. The UUID is provided as a pseudo-random number, i.e., information made up of 128 bits, for example.

In S704, the CPU 201 analyzes the workflow information stored in the HDD 204 and reads the limit date of the workflow. In S705, the CPU 201 calculates a limit date, which is to be notified to the worker taking in charge of a step 1, in accordance with a proper algorithm based on both the date when the PDL data has been received and the limit date. In this exemplary embodiment, S705 corresponds to a limit date calculation process.

In the case of FIG. 1, for example, the limit date calculated in S704 is a limit date that is to be notified to the worker 141. The limit date can be calculated as the number of days resulting from evenly dividing the number of days from the reception date of the PDL data to the final limit date by the number steps. Alternatively, the limit date can be calculated by assigning weights to the workers in consideration of their abilities.

In S706, the CPU 201 prepares E-mail data describing the limit date information. In this exemplary embodiment, S706 is included in a mail preparing process.

In S707, the CPU 201 refers to the mail address of the worker taking in charge of the step 1, which is set in the XML file illustrated in FIG. 6, and sends the prepared E-mail to the worker taking in charge of the step 1.

Finally, in S708, the CPU 201 executes rendering of the PDL data received in S701 and causes the PDL data to be printed by the printer 113. Thereafter, the processing is brought to an end. In such a manner, one or more printed-out sheets are circulated as the circulating document 150 among the workers.

An example of the E-mail data prepared in S706 will be described below.

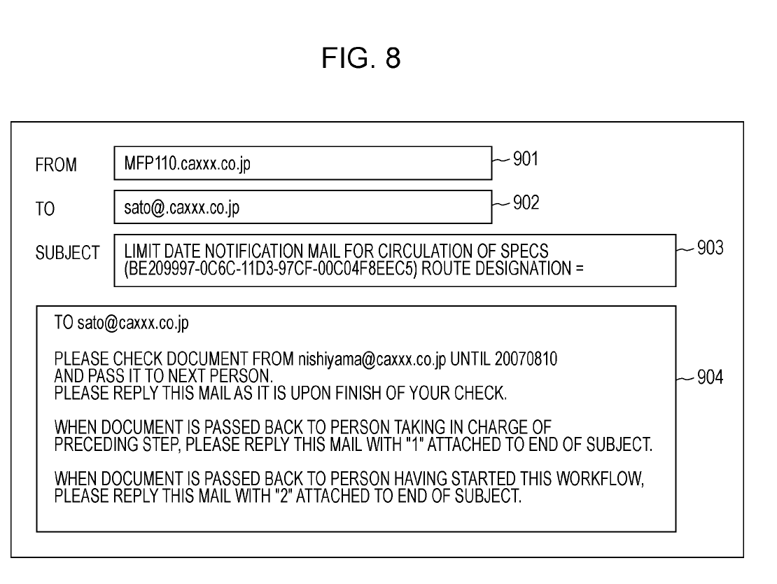

FIG. 8 illustrates an example of the E-mail data prepared by the image forming apparatus 110 illustrated in FIG. 1.

Referring to FIG. 8, the E-mail address of the image forming apparatus 110 is put in a “FROM” field 901. The E-mail address of the worker taking in charge of the step 1 is put in a “TO” field 902.

In the case illustrated in FIG. 1, for example, the worker taking in charge of the step 1 is the worker 141. The workflow caption is put in a “SUBJECT” field 903 along with ID information of the workflow. Herein, the ID information is provided as the ID information allocated in S703 of the flowchart illustrated in FIG. 7.

Limit date information to be notified to the relevant worker is put in a text field 904. The limit information put in the text field 904 is provided as date before the limit date 508 illustrated in FIG. 7, i.e., “2007/8/31”. FIG. 8 illustrates an example in which “20070810” is put as the limit date information.

Generally, when a paper document is circulated, the relevant worker can confirm until when the paper document should be circulated to the next worker, by receiving a mail in the text form illustrated in FIG. 8.

Though described in detail later, when the relevant worker replies the mail to the image forming apparatus 110, i.e., the sending source of the mail, at the timing of passing the paper document to the worker who takes in charge of the next step, a similar mail to that illustrated in FIG. 8 is sent from the image forming apparatus 110 to the worker taking in charge of the next step.

Such a mail includes a limit date that is to be kept by the worker taking in charge of the next step. In the case illustrated in FIG. 1, for example, when the worker 141 replies the mail, a limit date notification mail arrives at the worker 142.

When the workflow requires an approval by sealing for each step, there is a possibility that the document is passed (or stepped) back in the course of circulation.

When the document is passed back to the worker taking in charge of the preceding step, the mail is replied to the image forming apparatus 110 with, for example, “1” attached to the end of the subject. Responsively, the image forming apparatus 110 sends a limit date notification mail to the worker taking in charge of the preceding step.

When the document is passed back to the worker having started the workflow, the mail is replied with, for example, “2” attached to the end of the subject. Responsively, a limit date notification mail is sent to the worker having started the workflow.

The following description is made of an example of E-mail data replied to the image forming apparatus illustrated when the document is passed back to the preceding step.

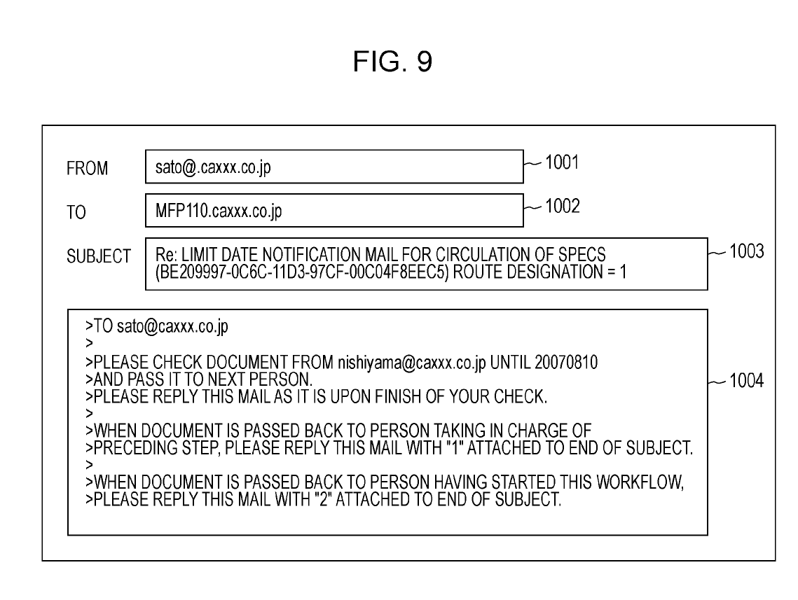

FIG. 9 illustrates an example of E-mail data replied to the image forming apparatus 110 illustrated in FIG. 1. This example represents the E-mail data replied to the image forming apparatus 110 when the document is passed back to the preceding step. While, in this exemplary embodiment, the E-mail data replied to the image forming apparatus 110 is prepared by the client terminal having received the mail, the worker having received the E-mail, illustrated in FIG. 8, can also reply an E-mail including a similar text to that illustrated in FIG. 9 to the image forming apparatus 110 by using another device. While the E-mail is a simple text mail in the illustrated example, a program can be installed to provide the function of, for example, highlighting a text of an E-mail or displaying characters in scrolled fashion. With such a modification, the worker having the E-mail can more quickly recognize an important item in the text. In addition, when the document is passed back to the worker taking in charge of the preceding step, the reason can also be stated in the mail.

Referring to FIG. 9, the E-mail address of the worker having passed back the document is put in a “FROM” field 1001. The E-mail address of the image forming apparatus 110 is put in a “TO” field 1002. “Re:” indicating a reply is set in a “SUBJECT” field 1003.

Further, because the mail in FIG. 9 is a reply mail when the document is passed back to the worker taking in charge of the preceding step, “1” is attached to the end of the subject in the “SUBJECT” field 1003. The contents of the text field 1004 need not to be revised.

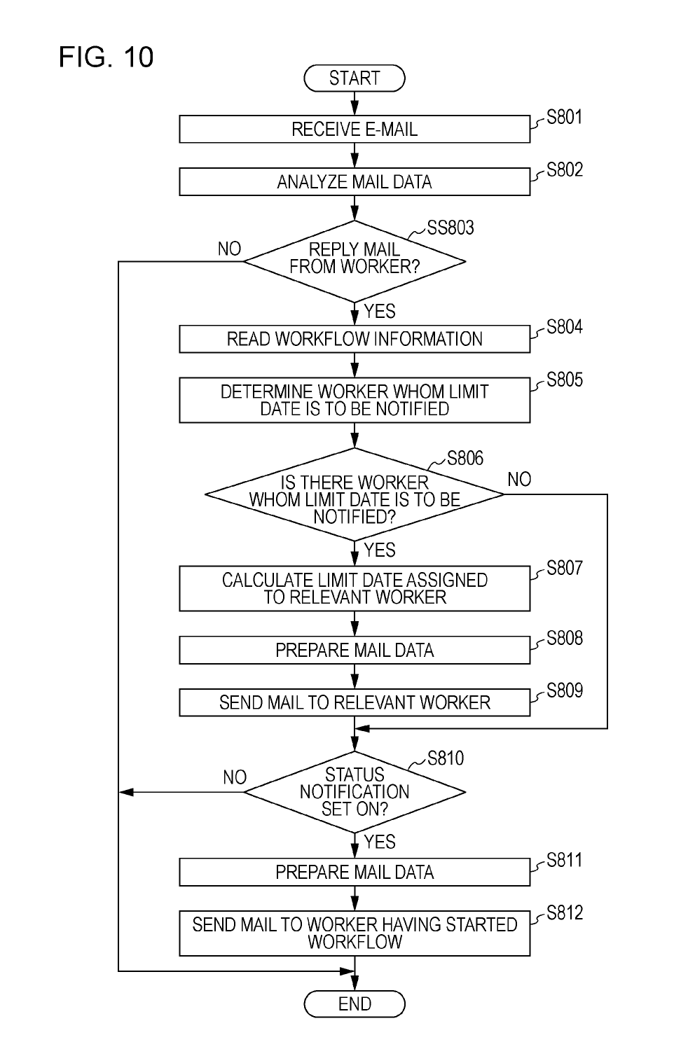

FIG. 10 is a flowchart illustrating an example of data processing procedures in the image forming apparatus representing the first exemplary embodiment. The illustrated example represents the processing executed in the image forming apparatus 110 when a reply mail is received from the worker in the workflow management process. In FIG. 10, S801 to S812 indicate successive steps. Those steps are executed by the CPU 201, illustrated in FIG. 2, executing the control program loaded in the RAM 203.

First, in S801, the CPU 201 receives an E-mail from some client terminal through the network I/F 206. Then, in S802, the CPU 201 analyzes mail data received from the client terminal. In S803, the CPU 201 determines whether the received mail is a reply mail from the worker. In this exemplary embodiment, the reply mail determined in S803 corresponds to a task completion mail sent from the worker.

In this exemplary embodiment, when an UUID is included in the subject as seen from the example of the reply mail illustrated in FIG. 9 and the workflow corresponding to the UUID is stored in the HDD 204, the CPU 201 determines that the received mail is the reply mail from the worker, and advances to S804. If the CPU 201 determines that the received mail is not the reply mail from the worker, the processing is brought to an end.

In S804, the CPU 201 reads, from the HDD 204, the workflow information corresponding to the UUID included in the subject. In S805, the CPU 201 obtains the E-mail address information of the worker whom a limit date is to be next notified.

In S806, the CPU 201 determines, based on the E-mail address put in the “FROM” field of the received mail, whether there remains the worker taking in charge of the next step. Stated another way, the CPU 201 determines, based on the workflow information, whether there remains the worker whom a limit date notification mail is to be sent. In this exemplary embodiment, S806 corresponds to a process of determining whether any worker scheduled to take in charge of the next step is set (i.e., a next step determining step).

If the CPU 201 determines that there is no next step, it advances to S810. If the CPU 201 determines that there is a next step, it advances to S807.

For example, when the reply mail from the worker 141 is received, the worker determined in S805 is the worker 142.

On the other hand, when the reply mail from the worker 143 is received, there is no next step. Accordingly, the determination result in S806 is “NO (N)” and the CPU 201 advances to S810.

In S807, the CPU 201 calculates a limit date that is to be kept by the worker taking in charge of the next step. Then, in S808, the CPU 201 prepares E-mail data based on the calculated limit date. The E-mail data prepared in S807 is similar to that illustrated in FIG. 9.

In S809, the CPU 201 sends a limit date notification mail to the relevant worker.

In the case of the workflow in which “YES” is set and registered in the field 509 of “STATUS NOTIFICATION” on the user interface provided by the printer driver, e.g., on the UI screen illustrated in FIG. 5, the CPU 201 advances to S811 upon determination of “YES” in S810. The setting of “YES” in the field 509 of “STATUS NOTIFICATION” serves as information requesting that progress information indicating a progress status for each step is notified upon completion of each step. In this exemplary embodiment, S810 corresponds to a request determination process of determining whether “YES” is set in the field 509 of “STATUS NOTIFICATION”.

In S811, the CPU 201 prepares a mail for notifying the progress status to the worker having started the workflow process (i.e., the print requesting person). In S812, the CPU 201 sends, to the worker having started the workflow process, the prepared mail for notifying the progress status to that worker. Thereafter, the processing is brought to an end. In this exemplary embodiment, if the determination result in S806 is “NO” and the determination result in S810 is “NO”, the processing is brought to an end. However, if the determination result in S810 is “NO”, this implies that the workflow process is already completed. Therefore, the processing can be modified to add such a step that the CPU 201 prepares a mail for notifying the completion of the workflow process and advances to S812 in which the prepared mail is sent to the worker having started the workflow process, thus enabling the relevant worker to confirm the completion of the workflow process.

Further, if it is described in step S803 that information indicating passing-back of the document (i.e., step-back of the workflow) to the worker taking in charge of the preceding step is set in the subject of the reply mail, a step-back request mail can also be sent to the worker taking in charge of the preceding step, thus requesting the relevant worker to check the passed-back document again.

In such a case, the CPU 201 prepares again a notification mail including information that indicates a limit date newly calculated for the worker taking in charge of the preceding step, and then sends again the mail to the worker taking in charge of the preceding step. Stated another way, a new limit date is recalculated and notified to the worker taking in charge of the preceding step.

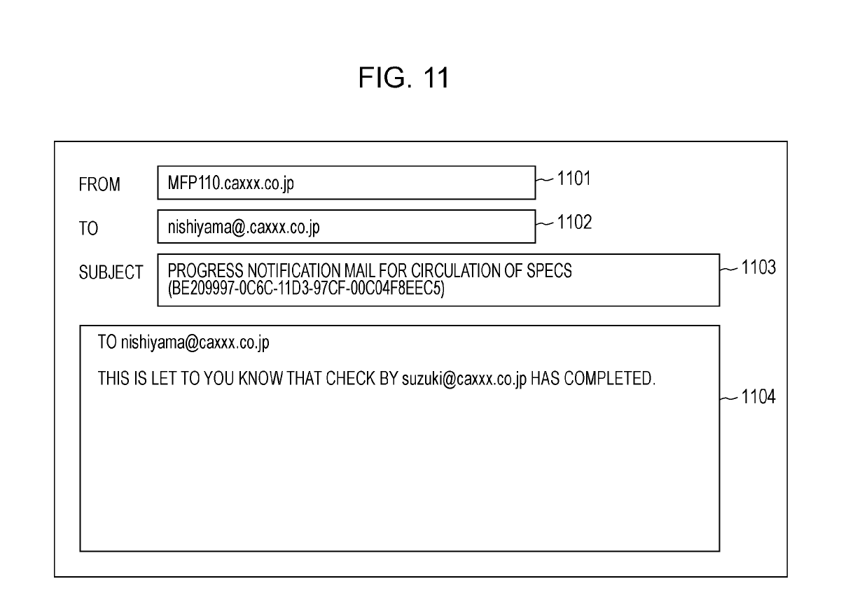

FIG. 11 illustrates an example of a reply mail sent from the image forming apparatus representing the first exemplary embodiment. The illustrated example indicates a mail sent in S812 from the image forming apparatus 110 to the worker having started the workflow process when the worker 142, illustrated in FIG. 1, sends a reply mail to the image forming apparatus 110.

As illustrated in FIG. 11, because the relevant mail is a mail sent from the image forming apparatus 110, the E-mail address of the image forming apparatus 110 is put in a “FROM” field 1101.

The E-mail address of the worker having started the workflow process is put in a “TO” field 1102. Further, the workflow caption and the ID information are put in a “SUBJECT” field 1103.

A message indicating completion of the task of the worker 142 is put in a text field 1104. Upon receiving such a reply mail, the worker 140 having started the workflow process can confirm the progress status of the workflow.

Even in the workflow for circulation of the paper document, as described above, each worker can be notified of, via an E-mail, a proper limit date assigned to the relevant worker. As a result, the entire workflow is less apt to stagnate in progress.

Further, the worker having started the workflow can confirm the progress status step by step. Hence, the worker having started the workflow can recognize in which step the workflow stagnates, and can request the worker taking in charge of that step to promote the task, as required.

### Second Exemplary Embodiment

While the workflow handled in the above-described first exemplary embodiment is not branched, the workflow can be modified so as to include a branch in the course of progress. A second exemplary embodiment representing such a case will be described below.

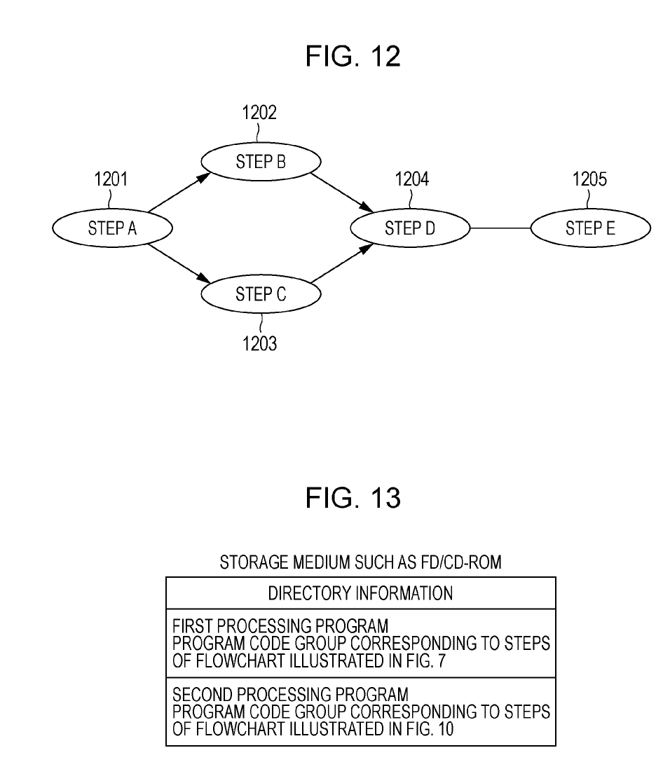

FIG. 12 illustrates an example of a step model in a workflow system representing the second exemplary embodiment. In the illustrated exemplary model, the workflow system is made up of steps A to E. The workflow is branched from the step A into the step B and the step C, which are executed in parallel. The step D is executed after completion of both the steps B and C. Thereafter, the step E is executed.

Referring to FIG. 12, the workflow in the second exemplary embodiment is progressed as illustrated in FIG. 12, for example, such that, after a step A 1201, the workflow is branched into a step B 1202 and a step C 1203, and a step D 1204 is executed after completion of both the step B 1202 and the step C 1203.

In the workflow illustrated in FIG. 12, after receiving two reply mails from the workers taking in charge of the step B 1202 and the step C 1203, the image forming apparatus 110 sends a limit date notification mail to the worker taking in charge of the step D 1204.

The configuration of data processing programs, which are readable by the image forming apparatus according to the first exemplary embodiment, will be described below with reference to a memory map of FIG. 13.

FIG. 13 illustrates a memory map in a storage medium storing various data processing programs, which are readable by the image forming apparatus according to the first exemplary embodiment.

Though not specifically illustrated in FIG. 13, information for managing a program group stored in the storage medium, such as version information and a writer's name, is also stored in some cases. Further, information depending on an OS (Operating System), etc. on the program reading side, such as icons for displaying the programs in an identifiable manner, is also stored in other cases.

In addition, data belonging to the various programs are managed in a directory illustrated in FIG. 13. A program for installing the various programs in a computer and a program for, when programs to be installed are compressed, decompressing those programs can also be stored as well.

The functions of the above-described exemplary embodiments, illustrated in FIGS. 7 and 10, can be executed by a host computer in accordance with programs which are externally installed into the host computer. On that occasion, the present invention is also applicable to the case that an information group, including the programs, is supplied to an output device from a storage medium, such as a CD-ROM, a flash memory or a FD, or from an external storage medium via a network.

Further, practical embodiments of the present invention include the following case. A storage medium recording software program code for realizing the functions of the above-described exemplary embodiments is supplied to a system or an apparatus. Then, a computer (CPU or MPU) incorporated in the system or the apparatus reads and executes the program code stored in the storage medium.

In that case, the program code read out from the storage medium realizes the novel functions of the present invention, and the storage medium storing the program code constitutes a practical embodiment of the present invention.

Therefore, the programs can have various forms, e.g., object code, programs executed by an interpreter, and script data supplied to the OS, so long as the programs have the required functions.

The storage medium for supplying the programs can be, e.g., a flexible disk, a hard disk, an optical disk, a magneto-optical disk (MO), a CD-ROM, a CD-R, a CD-RW, a magnetic tape, a nonvolatile memory card, a ROM, and a DVD.

Thus, the program code read out from the storage medium realizes the functions of the above-described exemplary embodiments, and the storage medium storing the program code constitutes a practical embodiment of the present invention.

Further, the programs can be supplied through the steps of connecting a client computer to a homepage on the Internet through a browser in the client computer, and downloading the computer programs implementing the features of the present invention in themselves or a file, which contains the computer programs in compressed form and which has an automatic installing function, to a recording medium, e.g., a hard disk, from the connected homepage. As another method, program code constituting the programs implementing the features of the present invention can be divided into a plurality of files, and those files can be downloaded from different homepages. In other words, practical embodiments of the present invention include a WWW server and an ftp server for downloading, to a plurality of users, a program file which realizes the functions and the processing executed in the present invention with a computer.

Alternatively, the programs can be supplied as follows. The programs implementing the features of the present invention are encrypted and stored in a storage medium, e.g., a CD-ROM, for distribution to users. The user who clears predetermined conditions is allowed to download key information necessary for decryption from a homepage via the Internet. The user decrypts and executes the encrypted programs by using the downloaded key information, thus installing the programs in a computer.

Practical embodiments of the present invention are not limited to the case that the functions of the above-described exemplary embodiments are realized with a computer executing the read program code. For example, the functions of the above-described exemplary embodiments can also be realized in such a manner that an OS, etc. operating on the computer executes a part or the whole of actual processing in accordance with instructions from the read program code.

The functions of the above-described exemplary embodiments can be further realized as follows. The program code read out from the storage medium is written in a function expansion board inserted in a computer or a memory incorporated in a function expansion unit connected to the computer. Then, a CPU or the like incorporated in the function expansion board or the function expansion unit executes a part or the whole of actual processing in accordance with instructions from the read program code.

The present invention is not limited to the above-described embodiments and can be practiced in various modifications (including organic combinations of embodiments) without departing from the gist of the present invention. Those modifications are not excluded from the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-120502 filed May 2, 2008, which is hereby incorporated by reference herein in its entirety.

What is claimed is:

1. An image forming apparatus configured to receive print information from an information processing apparatus and to process the print information, the image forming apparatus comprising:
a determining unit configured to determine whether the print information includes workflow information;
a limit date calculating unit configured to, when the determining unit determines that the print information includes the workflow information, analyze the workflow information and calculate a limit date until which a first step constituting a workflow is to be completed;
a mail preparing unit configured to prepare a notification mail which includes information indicating the limit date of the first step; and
a mail sending unit configured to send the notification mail prepared by the mail preparing unit to an address of a worker in charge of the first step, the address of the worker being specified based on the workflow information.

2. The image forming apparatus according to claim 1, further comprising:
a mail receiving unit configured to receive a task completion mail, which indicates completion of a step of the workflow, from the address of the worker having received the notification mail sent from the mail sending unit; and
a next-step determining unit configured to, upon receiving the task completion mail by the mail receiving unit, analyze the workflow information and determine whether a worker scheduled to take charge of a next step is set in the workflow information,
wherein, when the next-step determining unit determines that the worker scheduled to take charge of the next step is set, the mail sending unit sends a notification mail which includes information indicating a limit date of the next step, the limit date being calculated by the limit date calculating unit.

3. The image forming apparatus according to claim 2, wherein, when the next-step determining unit determines that the worker scheduled to take charge of the next step is not set, the mail sending unit sends a mail indicating completion of a final step to a print requesting person who has transmitted the print information.

4. The image forming apparatus according to claim 3, wherein the mail receiving unit includes a confirming unit configured to confirm whether a mail received from the address of the worker whom the notification mail has been sent from the mail sending unit is a step-back request mail which requests the workflow to be stepped back to the worker taking charge of a preceding step, and
wherein, when the confirming unit confirms that the received mail is the step-back request mail, the mail sending unit resends a notification mail which includes information indicating a limit date of the next step, the limit date being recalculated by the limit date calculating unit.

5. The image forming apparatus according to claim 1, wherein the workflow information includes step instruction information causing steps to be successively progressed while materials printed out based on the print information are circulated, mail addresses of workers taking charge of respective steps, deadline information indicating a final limit date until which the workflow is to be completed, and information requesting a progress status of each step to be notified per step.

6. The image forming apparatus according to claim 1, wherein, when the limit date calculating unit calculates the limit date until which each step is to be completed, the limit date calculating unit calculates the limit date in consideration of weight set for each step.

7. The image forming apparatus according to claim 5, further comprising:
a request determining unit configured to determine whether information requesting the progress status to be notified for each step is set,
wherein, when the request determining unit determines that the information requesting the progress status to be notified for each step is set, the mail sending unit sends, to a print requesting person, a progress mail including a workflow progress information whenever the mail receiving unit receives the task completion mail sent from each worker upon completion of each step.

8. An information processing apparatus configured to transmit print information to an image forming apparatus, the information processing apparatus comprising:
a setting unit configured to set workflow information for specifying a workflow with respect to the print information; and
a transmitting unit configured to transmit the workflow information to the image forming apparatus, the workflow information being included in the print information.

9. The information processing apparatus according to claim 8, wherein the workflow information includes step instruction information causing steps to be successively progressed while materials printed out based on the print information are circulated, mail addresses of workers taking charge of respective steps, and deadline information indicating a final limit date until which the workflow is to be completed.

10. The information processing apparatus according to claim 8, wherein the setting unit sets information requesting a progress status of each step to be notified per step.

11. A workflow management method for use in an image forming apparatus configured to receive print information from an information processing apparatus and to process the print information, the workflow management method comprising:
determining whether the print information includes workflow information;
upon a determination result indicating that the print information includes the workflow information, analyzing the workflow information and calculating a limit date until which a first step constituting a workflow is to be completed;
preparing a notification mail which includes information indicating the calculated limit date of the first step; and
sending the prepared notification mail to an address of a worker taking charge of the first step, the address of the worker being specified based on the workflow information.

12. The workflow management method according to claim 11, further comprising the steps of:
receiving a task completion mail, which indicates completion of a step of the workflow, from the worker having received the notification mail sent from the mail sending unit; and
upon receiving the task completion mail, analyzing the workflow information and determining whether a worker scheduled to take charge of a next step is set in the workflow information,
wherein, when a determination result indicates that the worker scheduled to take charge of the next step is set, a notification mail which includes information indicating a calculated limit date of the next step is sent.

13. The workflow management method according to claim 12, wherein, when the determination result indicates that the worker scheduled to take charge of the next step is not set, a mail indicating completion of a final step is sent to a print requesting person who has transmitted the print information.

14. The workflow management method according to claim 13, wherein receiving the mail includes confirming whether a mail received from the worker whom the notification mail has been sent is a step-back request mail which requests the workflow to be stepped back to the worker taking charge of a preceding step, and
wherein, when a confirmation result indicates that the received mail is the step-back request mail, a notification mail which includes information indicating a recalculated limit date of the next step is resent.

15. The workflow management method according to claim 11, wherein the workflow information includes step instruction information causing steps to be successively progressed while materials printed out based on the print information are circulated, mail addresses of workers taking charge of respective steps, deadline information indicating a final limit date until which the workflow is to be completed, and information requesting a progress status of each step to be notified per step.

16. The workflow management method according to claim 11, wherein, in calculating the limit date until which each step is to be completed, the limit date is calculated in consideration of weight set for each step.

17. The workflow management method according to claim 15, further comprising the step of:
determining whether information requesting the progress status to be notified for each step is set,
wherein, when a determination result indicates that the information requesting the progress status to be notified for each step is set, a progress mail including a workflow progress information is sent to a print requesting person whenever the task completion mail sent from the address of each worker upon completion of each step is received.

18. A workflow management method for use in an information processing apparatus configured to transmit print information to an image forming apparatus, the information processing method comprising the steps of:
setting workflow information for specifying a workflow with respect to the print information; and
transmitting the workflow information to the image forming apparatus, the workflow information being included in the print information.

19. The workflow management method according to claim 18, wherein the workflow information includes step instruction information causing steps to be successively progressed while materials printed out based on the print information are circulated, mail addresses of workers taking charge of respective steps, and deadline information indicating a final limit date until which the workflow is to be completed.

20. The workflow management method according to claim 18, wherein setting the workflow information includes setting information requesting a progress status of each step to be notified per step.

21. A computer-readable storage medium storing a program that causes a computer to execute the workflow management method comprising:
determining whether the print information includes workflow information;
upon a determination result indicating that the print information includes the workflow information, analyzing the workflow information and calculating a limit date until which a first step constituting a workflow is to be completed;
preparing a notification mail which includes information indicating the calculated limit date of the first step; and
sending the prepared notification mail to an address of a worker taking charge of the first step, the address of the worker being specified based on the workflow information.
